(19) United States
(12) Patent Application Publication
(10) Pub. No.: US 2026/0086473 A1
(43) Pub. Date: Mar. 26, 2026

(54) LIGHT EMITTING COMPONENT, OPTICAL WRITING DEVICE EQUIPPED WITH THE SAME, AND IMAGE FORMING SYSTEM

(71) Applicant: FUJIFILM Business Innovation Corp., Tokyo (JP)

(72) Inventors: Takashi FUJIMOTO, Kanagawa (JP); Seiji ONO, Kanagawa (JP)

(73) Assignee: FUJIFILM Business Innovation Corp., Tokyo (JP)

(21) Appl. No.: 19/068,135

(22) Filed: Mar. 3, 2025

(30) Foreign Application Priority Data
Sep. 26, 2024 (JP) 2024-167390

(51) Int. Cl. G03G 15/043

(52) U.S. Cl. CPC G03G 15/043; G03G 2215/0409

(57) ABSTRACT

A light emitting component includes: a substrate; an array-like light source unit that is provided at the substrate and in which multiple light emitting elements are arranged in a first scanning direction; a controller that is provided at the substrate and that controls an electric current to turn on and off each light emitting element of the light source unit; a resistor that is provided at the substrate and alongside an end of the light source unit in the first scanning direction, the resistor limiting the electric current supplied to each light emitting element; and a heat generator that is provided at the substrate and at a position located parallel to the first scanning direction of the light source unit and located away from the resistor, the heat generator generating a heat quantity that is smaller than a heat value dependent on electric power input to the resistor and that is proportional to the heat value.

### CROSS-REFERENCE TO RELATED APPLICATIONS

This application is based on and claims priority under 35 USC 119 from Japanese Patent Application No. 2024-167390 filed Sep. 26, 2024.

### BACKGROUND

### (i) Technical Field

The present disclosure relates to light emitting components, optical writing devices equipped with the same, and image forming systems.

### (ii) Related Art

Known light emitting components in the related art and known optical writing devices equipped with the same are described in, for example, Japanese Unexamined Patent Application Publication No. 2002-281240 (Exemplary Embodiments and FIG. 10), No. 2006-159472 (Exemplary Embodiments and FIG. 8), and No. H10-150236 (Exemplary Embodiments and FIG. 1).

Japanese Unexamined Patent Application Publication No. 2002-281240 discloses an image reading device having a heat generating element array constituted of, for example, resistors near a white LED element array. When the orientation distribution in a first scanning direction by the white LED element array is controlled, the image reading device evenly controls the temperature distribution of white LED joint areas by controlling the heat values of the heat generating elements regardless of the light-on mode or the light-off mode of the white LEDs. Alternatively, even when the LED element array is not driven, the image reading device controls the heat values of the heat generating elements to maintain the temperature distribution corresponding to when the LED element array alone is driven.

Japanese Unexamined Patent Application Publication No. 2006-159472 discloses a light emitting unit having a diode and two load resistors. The light emitting unit has a substrate equipped with a reference voltage generating circuit and a drive IC. The reference voltage generating circuit divides a power source voltage by using the diode and the load resistors and outputs a reference voltage. The drive IC drives an LED element based on the reference voltage.

Japanese Unexamined Patent Application Publication No. H10-150236 discloses a semiconductor-light-emitting-element drive circuit including a thermal equivalent circuit that simulates a temporal change in heat generation when electric current is supplied to a laser diode, a first current source that generates a drive current to be supplied to the laser diode, and a second current source that generates a monitor current corresponding to a drive power and supplies the monitor current to the thermal equivalent circuit. The first current source generates the drive current controlled to compensate for a change in the quantity of emitted light according to heat generation based on a simulated heat value of the laser diode.

### SUMMARY

Aspects of non-limiting embodiments of the present disclosure relate to a light emitting component, an optical writing device equipped with the same, and an image forming system that may suppress a variation difference in the temperature distribution in the array direction of multiple light emitting elements of a light source unit having the light emitting elements arranged therein so as to reduce a light-quantity-distribution variation for every lighting condition.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a light emitting component including: a substrate; an array-like light source unit that is provided at the substrate and in which a plurality of light emitting elements are arranged in a first scanning direction; a controller that is provided at the substrate and that controls an electric current to turn on and off each light emitting element of the light source unit; a resistor that is provided at the substrate and alongside an end of the light source unit in the first scanning direction, the resistor limiting the electric current supplied to each light emitting element; and a heat generator that is provided at the substrate and at a position located parallel to the first scanning direction of the light source unit and located away from the resistor, the heat generator generating a heat quantity that is smaller than a heat value dependent on electric power input to the resistor and that is proportional to the heat value.

### BRIEF DESCRIPTION OF THE DRAWINGS

Exemplary embodiments of the present disclosure will be described in detail based on the following figures, wherein:

FIG. 1A illustrates the general outline of an image forming system according to an exemplary embodiment of the present disclosure, FIG. 1B illustrates a configuration example of a light emitting element chip of a light emitting component used in FIG. 1A, and FIG. 1C illustrates the operation of the light emitting element chip;

FIG. 2 illustrates the overall configuration of an image forming system according to a first exemplary embodiment;

FIG. 3 illustrates an example of an optical writing device used in the image forming system according to the first exemplary embodiment;

FIG. 4A is a perspective view illustrating a configuration example of the optical writing device shown in FIG. 3, and FIG. 4B illustrates a light-emitting-element-chip array used in the optical writing device;

FIG. 5A illustrates a configuration example of a light emitting element chip used in the light-emitting-element-chip array according to the first exemplary embodiment, and FIG. 5B illustrates a temperature characteristic of the light emitting element chip shown in FIG. 5A;

FIG. 6 illustrates a circuit configuration example of the light emitting element chip according to the first exemplary embodiment;

FIG. 7 illustrates operation signals of sections of the light emitting element chip according to the first exemplary embodiment;

FIG. 8A illustrates a configuration example of a light emitting element chip according to a first comparative embodiment, and FIG. 8B illustrates a temperature characteristic of the light emitting element chip shown in FIG. 8A;

FIG. 9A illustrates a configuration example of a light emitting element chip according to a second exemplary embodiment, and FIG. 9B illustrates a temperature characteristic of the light emitting element chip shown in FIG. 9A;

FIG. 10 illustrates a circuit configuration example of the light emitting element chip according to the second exemplary embodiment;

FIG. 11 illustrates a configuration example of a light emitting element chip according to a third exemplary embodiment;

FIG. 12 illustrates a circuit configuration example of the light emitting element chip according to the third exemplary embodiment;

FIG. 13 is a partially enlarged view of FIG. 12;

FIG. 14A illustrates a configuration example of a light emitting element chip according to a fourth exemplary embodiment, and FIG. 14B illustrates a temperature characteristic of the light emitting element chip shown in FIG. 14A;

FIG. 15 illustrates a circuit configuration example of the light emitting element chip according to the fourth exemplary embodiment;

FIG. 16 illustrates a specific example of the circuit configuration example of the light emitting element chip according to the fourth exemplary embodiment;

FIG. 17A illustrates a configuration example of a light emitting element chip according to a fifth exemplary embodiment, and FIG. 17B illustrates a temperature characteristic of the light emitting element chip shown in FIG. 17A; and

FIG. 18A is a graph illustrating a light-quantity change for every light-on rate of a light emitting element chip according to a first comparative example, and FIG. 18B is a graph illustrating a temperature change for every light-on rate of the light emitting element chip according to the first comparative example.

### DETAILED DESCRIPTION

### General Outline of Exemplary Embodiment

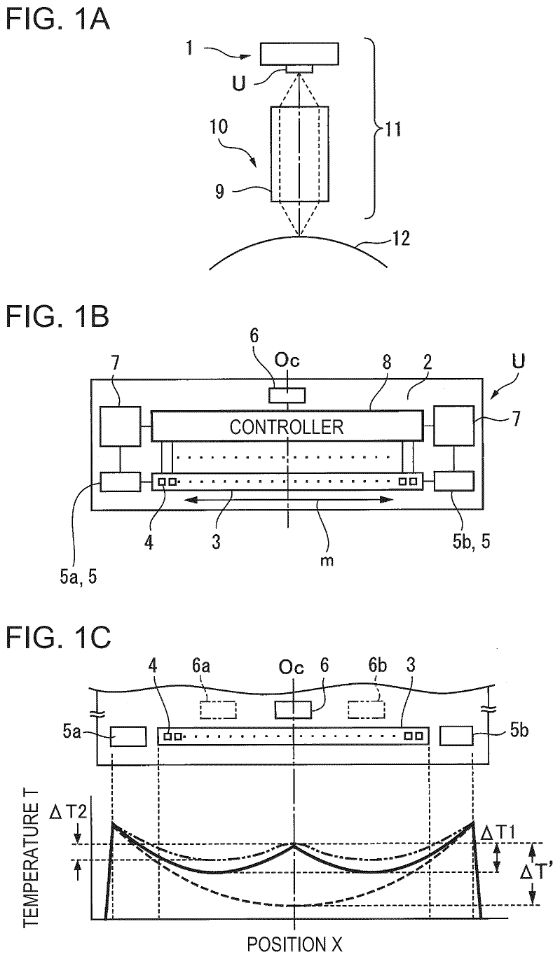

FIG. 1A illustrates the general outline of an image forming system according to an exemplary embodiment of the present disclosure.

In FIG. 1A, an image forming system 10 includes an optical writing device 11 and an image retainer 12 that is provided facing the optical writing device 11 and that retains an image according to light written by the optical writing device 11.

The optical writing device 11 includes a light emitting component 1 and an imaging unit 9 that causes light output from each light emitting element chip U of the light emitting component 1 to form an image on the image retainer 12 where the image according to the light is retainable. Moreover, the optical writing device 11 writes the image according to the light onto the image retainer 12.

The image retainer 12 mentioned here is not limited to a photosensitive member and may include, for example a dielectric member, and may have an appropriately-selected shape, such as a drum-like shape or a belt-like shape. An example of the image according to the light includes an electrostatic latent image having a potential difference by being electrostatically charged to a predetermined level and subsequently having the electrostatic charge removed therefrom by light according to an image pattern.

The imaging unit 9 may be of an appropriately-selected type, such as a lens (e.g., a cylindrical lens) that refracts light on the surface thereof or a lens (e.g., a gradient index lens) that refracts light therein, so long as the imaging unit 9 causes the light output from each light emitting element chip U of the light emitting component 1 to form an image on the image retainer 12.

As shown in FIG. 1B, each light emitting element chip U includes a substrate 2, an array-type light source unit 3 provided at the substrate 2 and having multiple light emitting elements 4 arranged in a first scanning direction, a controller 8 that is provided at the substrate 2 and that controls the electric current to turn on and off each light emitting element 4 of the light source unit 3, a resistor 5 that is provided at the substrate 2 alongside ends of the light source unit 3 in the first scanning direction and that limits the electric current supplied to each light emitting element 4, and a heat generator 6 that is provided at the substrate 2 at a position located parallel to the first scanning direction of the light source unit 3 and away from the resistor 5. The heat generator 6 generates a heat quantity that is smaller than a heat value dependent on the electric power input to the resistor 5 and that is proportional to the heat value.

In FIG. 1B, m denotes the first scanning direction. Each reference sign 7 denotes an electrode pad for supplying a predetermined electric power to, for example, the controller 8 and the resistor 5 by being connected to an electric power supplier (not shown) included in the light emitting component 1.

In such a technical configuration, the array-type light source unit 3 may be of any appropriately-selected type so long as it has the multiple light emitting elements 4 arranged in the first scanning direction. Each light emitting element 4 may be a light emitting thyristor capable of varying the light quantity, but is not limited thereto and may include a light emitting diode.

The controller 8 may include, for example, a light-on circuit and a light-off circuit for the light emitting elements 4.

The resistor 5 is often provided alongside the ends of the array-type light source unit 3 in the first scanning direction to reduce routing of wires and to readily ensure the installation space for the resistor 5.

Furthermore, in the example shown in FIG. 1B, the resistor 5 (i.e., 5a and 5b) is provided at each of opposite sides of the array-type light source unit 3 in the first scanning direction. This is to supply electric power from the opposite sides of the light source unit 3 in the first scanning direction to suppress a decrease in voltage caused by the resistance of wires to the light emitting elements 4, as compared with when the electric power is supplied from one side, thereby making the light quantities from the light emitting elements 4 uniform.

The heat generator 6 is not limited to a single unit and may include multiple units.

The heat generator 6 may be of any type so long as it generates a heat quantity that is smaller than the heat value dependent on the electric power input to the resistor 5 and that is proportional to the heat value. The reason for providing an upper limit for the heat value of the heat generator 6 is to eliminate the concern of an increased variation difference in the temperature distribution in the array direction of the light emitting elements 4 of the light source unit 3. The heat value of the heat generator 6 may be appropriately selected from heat quantities proportional to the heat value of the resistor 5. In detail, the heat value of the heat generator 6 may be selected from the standpoint of suppressing a variation difference in the temperature distribution in the array direction of the array of light emitting elements 4 of the light source unit 3.

In particular, in a configuration provided with multiple heat generators 6, a heat quantity allocated to the heat generator 6 located toward a center Oc in the first scanning direction of the light source unit 3 may be greater than a heat quantity allocated to the remaining one or more heat generators.

With regard to the position where the heat generator 6 is disposed, regions located toward the ends of the light source unit 3 in the first scanning direction may be excluded. If heat generators 6 are provided in correspondence with the regions located toward the ends of the light source unit 3 in the first scanning direction, the following problem occurs. Specifically, the end regions of the light source unit 3 increase in temperature by being heated more and more, possibly further increasing a temperature difference in the temperature distribution of the light source unit 3.

Each light emitting element chip U having the above configuration operates as follows.

Specifically, as shown in FIG. 1C, a temperature change occurs in the first scanning direction of the light source unit 3 within the light emitting element chip U due to heat generated by the resistor 5 (5a and 5b). In each light emitting element 4, the light quantity decreases with increasing temperature. Because the heat value of the resistor 5 changes due to different light-on rates, the temperature distribution and the light-quantity distribution change. Supposing that the heat generator 6 is not provided, the temperature distribution of the array of light emitting elements 4 of the light source unit 3 changes as indicated by a dotted line in FIG. 1C. The temperature distribution indicated by the dotted line in FIG. 1C has the shape of a quadratic curve of a temperature difference ΔT′ in which the center in the first scanning direction is at the lowest and the opposite sides in the first scanning direction are high.

However, in this exemplary embodiment, the heat generator 6 is provided parallel to the first scanning direction of the light source unit 3. Regions other than the ends of the array of light emitting elements 4 in the light source unit 3 are heated in accordance with the heat value from the heat generator 6.

For example, it is assumed that a single heat generator 6 is provided and is disposed in correspondence with a position including the center Oc in the first scanning direction of the light source unit 3. In this case, as indicated by a solid line in FIG. 1C, the temperature distribution of the array of light emitting elements 4 of the light source unit 3 is such that the temperature increases near the center Oc in the first scanning direction of the light source unit 3. Therefore, the temperature distribution indicated by the solid line in FIG. 1C changes to a state where a temperature difference ΔT1 (ΔT1<ΔT′) has decreased, as compared with a case where the heat generator 6 is not provided.

Furthermore, it is assumed that multiple heat generators 6 (e.g., 6a and 6b) are provided and are disposed symmetrically with respect to the center Oc in the first scanning direction of the light source unit 3. In this case, as indicated by a two-dot chain line in FIG. 1C, the temperature distribution of the array of light emitting elements 4 of the light source unit 3 is such that the temperature increases near where the heat generators 6 (6a and 6b) are disposed. Therefore, the temperature distribution indicated by the two-dot chain line in FIG. 1C changes to a state where a temperature difference ΔT2 (ΔT2<ΔT′) has decreased, as compared with a case where the heat generator 6 is not provided.

Accordingly, the temperature distribution of the array of light emitting elements 4 of the light source unit 3 is such that the temperature increases in the regions other than the ends, thereby resulting in a change in shape in which the temperature difference is alleviated. Thus, the change in the shape of the temperature distribution of the light source unit 3 undergoes a correction to a small temperature difference for each of lighting conditions (light-on rate and brightness) of the light source unit 3.

Although the resistor 5 and the heat generator 6 are separately provided in this exemplary embodiment, the configuration is not limited to this.

For example, the heat generator 6 may serve as a part of the resistor 5 and may be disposed by being changed from a position located alongside the end of the light source unit 3 in the first scanning direction to a position located parallel to the first scanning direction of the light source unit 3.

Furthermore, the resistor 5 may be divided into multiple sets in correspondence with division of the array of light emitting elements 4 of the light source unit 3 into multiple sets. In this case, the heat generator 6 may be configured by utilizing any of the sets of resistors 5.

In this example, the heat generator 6 is configured to constantly generate heat in accordance with the electric power input to the resistor 5. However, if the electric power input to the resistor 5 is low, the variation difference in the temperature distribution in the array direction of the light emitting elements 4 of the light source unit 3 is smaller than in a case where the electric power input to the resistor 5 is high. For example, the electric power input to the resistor 5 increases and decreases dependently on the light-on rate of the light emitting elements 4 of the light source unit 3. Thus, the electric power input to the resistor 5 decreases when the light-on rate of the light emitting elements 4 is low. In contrast, the electric power input to the resistor 5 increases when the light-on rate of the light emitting elements 4 is high.

Therefore, the heat generator 6 may be configured to generate heat when the electric power input to the resistor 5 is higher than or equal to a predetermined threshold value and not generate heat when the electric power input to the resistor 5 is lower than the threshold value.

Exemplary embodiments of the present disclosure shown in the appended drawings will be described below in further detail.

### First Exemplary Embodiment

### Overall Configuration of Image Forming System

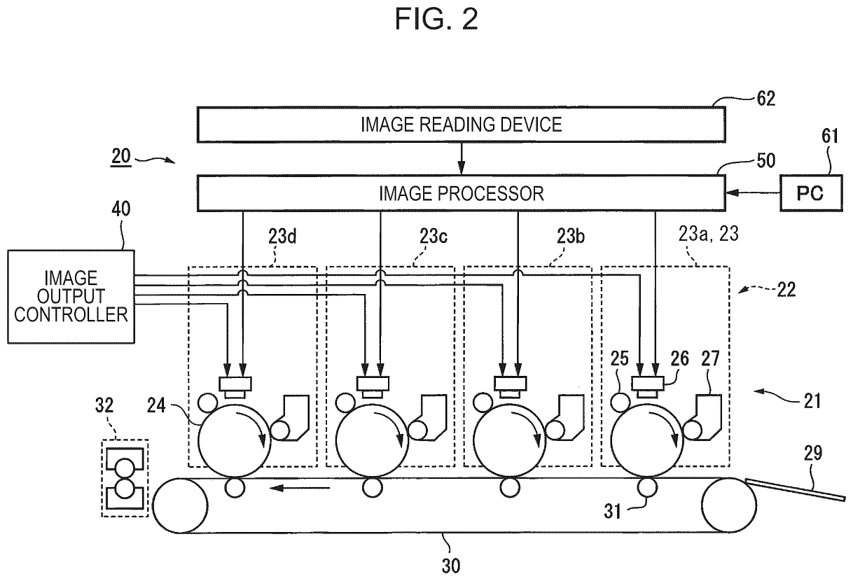

FIG. 2 illustrates the overall configuration of an image forming system according to a first exemplary embodiment.

In FIG. 2, an image forming system 20 is a so-called tandem image forming system. The image forming system 20 includes an image formation processing unit 21, an image output controller 40, and an image processor 50. The image formation processing unit 21 is a functional unit that performs image formation in correspondence with image data for each color. The image output controller 40 is a functional unit that controls the image formation processing unit 21. The image processor 50 is connected to, for example, a personal computer (PC) 61 and an image reading device 62, and performs predetermined image processing on image data received therefrom.

The image formation processing unit 21 includes image forming units 22 disposed parallel to each other with a fixed distance therebetween. The image forming units 22 are constituted of four image forming engines 23 (23a to 23d) serving as examples of toner image forming units. The toner image forming units are functional units that form toner images of four colors (i.e., yellow (Y), magenta (M), cyan (C), and black (K) colors in this example). Each of the image forming engines 23 (23a to 23d) includes an image retainer that forms an electrostatic latent image and retains a toner image. In this example, for example, a drum-shaped photosensitive member 24 is used as an example of each image retainer. The photosensitive member 24 is surrounded by a charging device 25, an optical writing device 26, and a developing device 27. The charging device 25 electrostatically charges the surface of the photosensitive member 24 uniformly with a predetermined potential. The optical writing device 26 exposes the photosensitive member 24 electrostatically charged by the charging device 25 to light so as to form an electrostatic latent image. The developing device 27 develops the electrostatic latent image formed by the optical writing device 26.

The image forming engines 23 (23a to 23d) respectively form yellow (Y), magenta (M), cyan (C), and black (K) toner images.

The image formation processing unit 21 transfers and fixes the multiple toner images of the respective colors formed on the photosensitive members 24 of the image forming engines 23 (23a to 23d) onto recording paper 29 as an example of a recording medium. In this example, the image formation processing unit 21 includes a sheet transport belt 30, transfer devices 31, and a fixing device 32. The sheet transport belt 30 transports the recording paper 29. The transfer devices 31 transfer the toner images on the photosensitive members 24 onto the recording paper 29, and are transfer rollers in this example. The fixing device 32 fixes the transferred toner images onto the recording paper 29.

In this image forming system 20, the image formation processing unit 21 performs image forming operation based on various control signals supplied from the image output controller 40. When image data is received from the personal computer (PC) 61 or the image reading device 62, the image data is processed as follows. Specifically, the image data undergoes image processing by the image processor 50 under the control of the image output controller 40, and is supplied to the image forming engines 23.

Then, for example, in the black (K) image forming engine 23d, the photosensitive member 24 is electrostatically charged to a predetermined potential by the charging device 25 while rotating in the direction of the arrow. Subsequently, the photosensitive member 24 is exposed to light emitted by the optical writing device 26 based on the image data supplied from the image processor 50. Accordingly, an electrostatic latent image related to a black (K) image is formed on the photosensitive member 24. The electrostatic latent image formed on the photosensitive member 24 is developed by the developing device 27, so that a black (K) toner image is formed on the photosensitive member 24. Likewise, yellow (Y), magenta (M), and cyan (C) toner images are formed in the image forming engines 23 (23a to 23c).

The multiple toner images formed on the photosensitive members 24 in the image forming engines 23 (23a to 23d) are transferred onto the recording paper 29. In this example, the recording paper 29 is fed in accordance with movement of the sheet transport belt 30 that moves in the direction of the arrow. Then, the toner images are sequentially electrostatically transferred in accordance with a transfer electric field applied to the transfer devices 31 (transfer rollers). Consequently, a combined toner image with the toners of the respective colors superposed one on top of another is formed on the recording paper 29.

Subsequently, the recording paper 29 having the combined toner image electrostatically transferred thereon is transported to the fixing device 32. Then, the combined toner image on the recording paper 29 undergoes a fixing process by being heated and pressed by the fixing device 32 so as to become fixed onto the recording paper 29, and is output from the image forming system 20.

### Configuration Example of Optical Writing Device

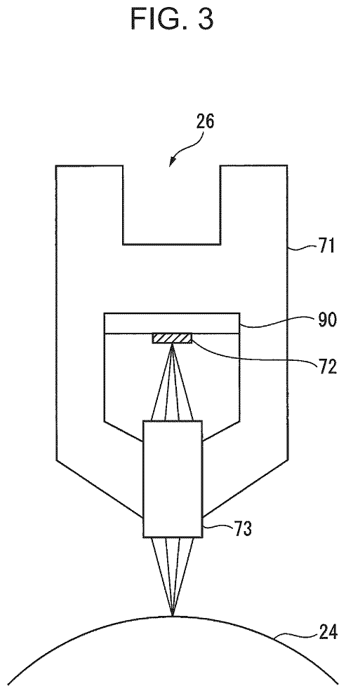

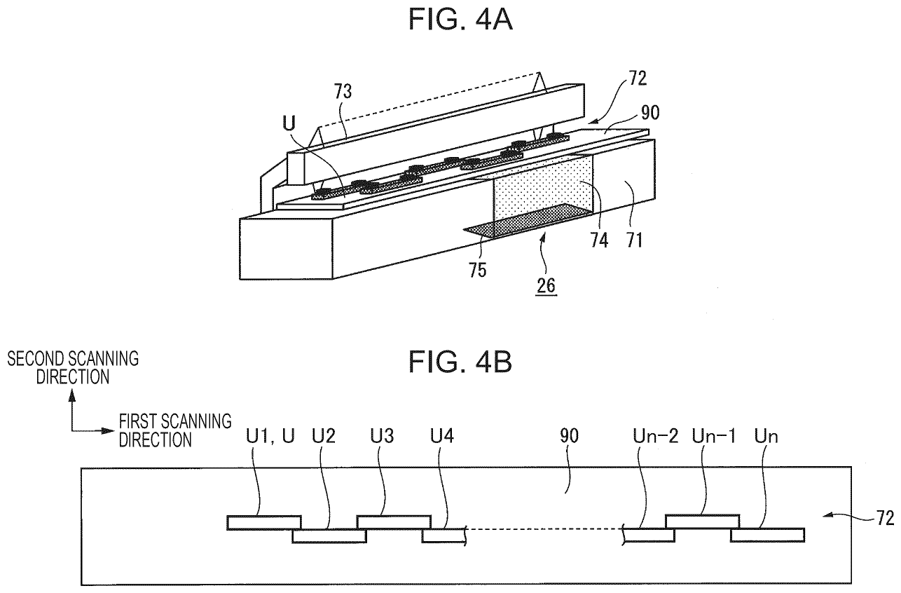

FIG. 3 illustrates a configuration example of the optical writing device 26 according to this exemplary embodiment, and FIG. 4A is a perspective view thereof.

In FIGS. 3 and 4A, the optical writing device 26 includes a device housing 71, a light-emitting-element-chip array 72, and an imaging lens 73 as an example of an imaging unit.

The light-emitting-element-chip array 72 is supported by the device housing 71 and includes multiple light emitting diodes (LEDs) as light emitting elements. The imaging lens 73 is supported by the device housing 71, causes light output from the light emitting elements of the light-emitting-element-chip array 72 to form an image, and exposes the photosensitive member 24 to light to form an electrostatic latent image.

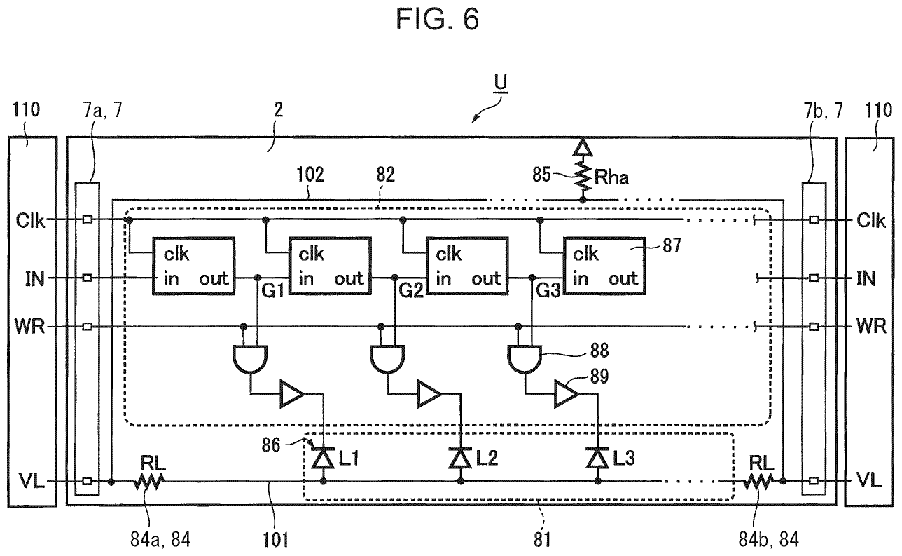

In this example, the device housing 71 is composed of, for example, metal and supports the light-emitting-element-chip array 72 and the imaging lens 73. The device housing 71 aligns a light emission point of each light emitting element 86 (see FIG. 6) of the light-emitting-element-chip array 72 with a focal plane of the imaging lens 73. The imaging lens 73 is disposed in an axial direction (corresponding to the first scanning direction) of the photosensitive member 24.

The light-emitting-element-chip array 72 is connected to a control substrate 75 equipped with a signal generating circuit (not shown) with a flexible substrate 74 interposed therebetween.

### Configuration Example of Light-Emitting-Element-Chip Array

FIG. 4B illustrates a configuration example of the light-emitting-element-chip array 72.

In FIG. 4B, the light-emitting-element-chip array 72 has multiple light emitting element chips U (U1 to Un) that are disposed in a staggered pattern on a circuit substrate 90 and that are arranged in two arrays facing each other in the first scanning direction. In each of the light emitting element chips U (U1 to Un), light emitting elements are arranged in the first scanning direction. Furthermore, various control signals from a signal generating circuit 110 (see FIG. 6) included in the control substrate 75 are used for light-on and light-off control of the light emitting elements 86 in the multiple light emitting element chips U. Accordingly, the signal generating circuit 110 individually controls the light emission of each light emitting element 86.

In this example, the light emitting element chips U are disposed in the staggered pattern due to the following reason. The reason is to avoid an inability to make the distance between the light emitting elements uniform at the ends of the light emitting element chips U if the multiple light emitting element chips U are arranged in one direction.

### Configuration Example of Light Emitting Element Chip U

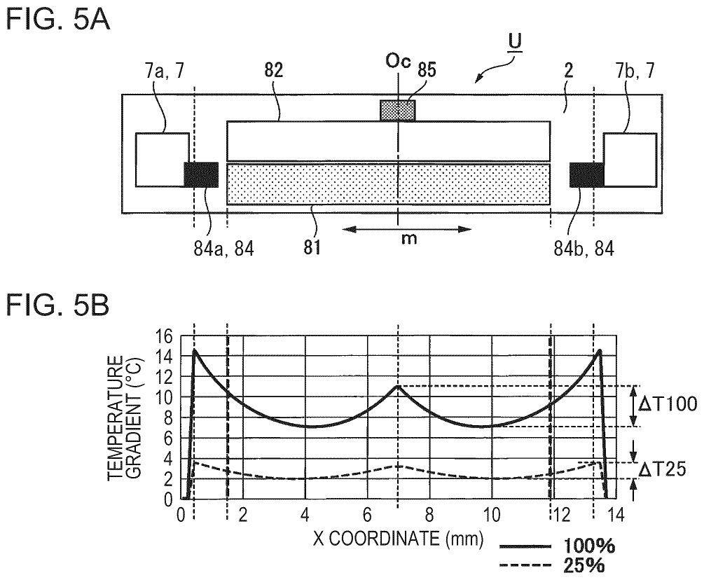

In this example, as shown in FIG. 5A, the light emitting element chip U has the substrate 2 whose surface has a long rectangular shape. The surface of the substrate 2 is provided with a light-emission-point array 81 as an array-like light source unit in which multiple light emitting elements are arranged in an array along one long edge. In this example, the light-emission-point array 81 is configured such that light emitting diodes (LEDs) as light emitting elements serve as light emission points (i.e., point-like light emitting regions). In this example, the array direction of the light emitting elements is treated as the first scanning direction, whereas a direction orthogonally intersecting the first scanning direction is treated as a second scanning direction.

Moreover, the surface of the substrate 2 is provided with a light-emission-point controller 82 as a controller that sequentially performs light-on and light-off control on the light emitting elements of the light-emission-point array 81.

Furthermore, the opposite lengthwise ends of the surface of the substrate 2 are provided with electrode pads 7 (i.e., 7a and 7b) as power suppliers. The electrode pads 7 load various control signals from the signal generating circuit 110 included in the control substrate 75.

In this example, the electrode pads 7 are connected so as to supply electric power to the light emitting elements of the light-emission-point array 81 from both of the pair of pads and are configured to input control signals to the light-emission-point controller 82.

In this example, the surface of the substrate 2 is provided with current limiting resistors 84 as resistors alongside the opposite ends of the light-emission-point array 81 in the first scanning direction. More specifically, the current limiting resistors 84 (i.e., 84a and 84b) are disposed in regions between the light-emission-point array 81 and the electrode pads 7. The installation spaces of the current limiting resistors 84 are selected in view of the fact that the regions between the light-emission-point array 81 and the electrode pads 7 are regions with less routing of wires. In this example, each current limiting resistor 84 limits the electric current to be supplied to each light emitting element of the light-emission-point array 81.

Furthermore, in this example, the surface of the substrate 2 is provided with a single heat generating source 85 as a heat generator at a position located parallel to the first scanning direction of the light-emission-point array 81. A resistance element is used as the heat generating source 85 and is disposed at a position located away from the current limiting resistors 84 (84a and 84b). In this example, the heat generating source 85 is disposed in correspondence with a position including the center Oc in the first scanning direction of the light-emission-point array 81.

The heat generating source 85 is selected such that it generates a heat quantity that is smaller than a heat value dependent on the electric power input to the current limiting resistors 84 and that is proportional to the heat value. The heat quantity generated from the heat generating source 85 is appropriately selected within a range of, for example, 0.3 times to 0.9 times (e.g., 0.8 times) the heat value dependent on the electric power input to the current limiting resistors 84.

### Each Element of Light Emitting Element Chip

### Electrode Pad

In this example, as shown in FIG. 6, each electrode pad 7 includes terminals corresponding to a Clk terminal, an IN terminal, a WR terminal, and a VL terminal of the signal generating circuit 110. The Clk terminal is a terminal that inputs a clock signal serving a reference operation timing to the light-emission-point controller 82. The IN terminal is a terminal that inputs, to the light-emission-point controller 82, a start signal of an image signal sequence involved in switching of the second scanning direction. The WR terminal is a terminal that inputs an image signal (H or L) indicating a light-on mode or a light-off mode to the light-emission-point controller 82. The VL terminal is a terminal that supplies a reference potential to the light-emission-point array 81.

### Light-Emission-Point Array

In this example, as shown in FIG. 6, the light-emission-point array 81 has light emitting elements 86 constituted of LEDs that are arranged in an array in the first scanning direction. In FIG. 6, the light emitting elements 86 are indicated as L1, L2, L3, and so on.

In this example, the anodes (positive electrodes) of the light emitting elements 86 are connected to a reference potential line (VL=6V) extending from the VL terminals.

With regard to the term “array” in the light-emission-point array 81, a representative pattern is such that the multiple light emitting elements 86 are arranged in a single line, as shown in FIG. 6. However, the term “array” in this example is not limited to the single-line arrangement and may include a pattern similar thereto. For example, the multiple light emitting elements 86 may be disposed with different displacement amounts in the direction orthogonal to the array direction. Alternatively, for example, when light emitting surfaces of the light emitting elements 86 are defined as pixels, each light emitting element 86 may be disposed with a displacement amount equivalent to several pixels or several tens of pixels in the direction orthogonal to the array direction. As another alternative, neighboring light emitting elements 86 may be alternately disposed in a zigzag pattern or every multiple number of light emitting elements 86 may be disposed in a zigzag pattern.

### Light-Emission-Point Controller

In this example, as shown in FIG. 6, the light-emission-point controller 82 includes multiple flip-flops 87, multiple AND gates 88, and multiple buffer circuits 89.

In this example, the flip-flops 87 are arranged in multiple levels in correspondence with the number of light emitting elements 86 in the light-emission-point array 81. Each flip-flop 87 has a clock input terminal (clk), an input terminal (in), and an output terminal (out). Each buffer circuit 89 is constituted of, for example, a transistor. In this example, each flip-flop 87, each AND gate 88, and each buffer circuit 89 constitute a so-called shift register circuit.

In this example, the clock signal from the Clk terminal of each electrode pad 7 is input to the clock input terminal (clk) of each flip-flop 87. The start signal of the image signal sequence in the second scanning direction from the IN terminal of the electrode pad 7 is input to the input terminal (in) of the flip-flop 87 at the first level. The output terminal (out) of the flip-flop 87 at the previous level and the input terminal (in) of the flip-flop 87 at the subsequent level are connected to each other.

One of input terminals of each AND gate 88 receives a serial image signal (H=3.3 V or L=0) from the WR terminal of each electrode pad 7. The other input terminal of the AND gate 88 receives an output signal G (G1, G2, G3, . . . ) from the output terminal (out) of the corresponding flip-flop 87.

An output from each AND gate 88 is input to the corresponding buffer circuit 89, and an output terminal of the buffer circuit 89 and a cathode of the corresponding light emitting element 86 are connected to each other.

### Current Limiting Resistor

In this example, the current limiting resistors 84 are series-connected to the cathodes of the light emitting elements 86 on a reference potential line 101 extending from the VL terminals of the electrode pads 7. In FIG. 6, each of the current limiting resistors 84 (i.e., 84a and 84b) is indicated as RL.

### Heat Generating Source

The heat generating source 85 is connected near the center of a second reference potential line 102 disposed in parallel with the reference potential line 101 extending from the VL terminals of the electrode pads 7. In this example, the reference potential line 101 and the second reference potential line 102 are supplied with electricity at the light emission timing of each light emitting element 86.

In FIG. 6, the heat generating source 85 is indicated as a resistor Rha.

### Actuation of Light Emitting Element Chip

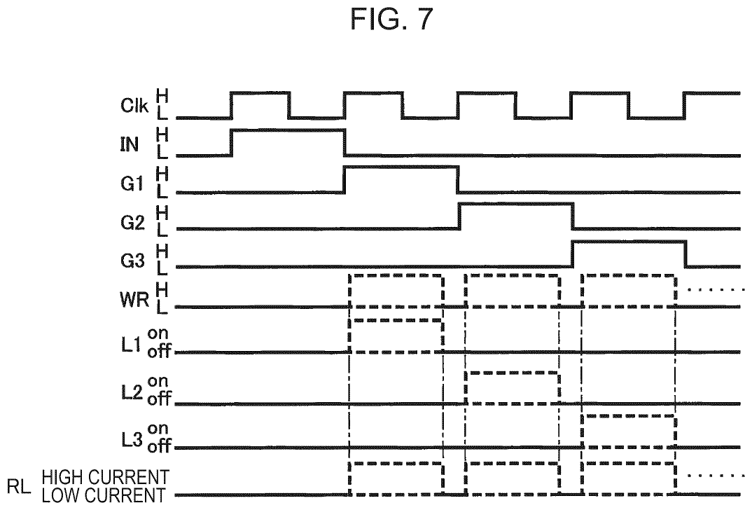

FIG. 7 illustrates operation signals of sections of the light emitting element chip according to the first exemplary embodiment.

In FIG. 7, each flip-flop 87 of the light-emission-point controller 82 receives a clock signal from the corresponding electrode pad 7.

The input terminal (in) of the flip-flop 87 at the first level in the light-emission-point controller 82 receives a start signal of an image signal sequence involved in switching of the second scanning direction. As a result, output signals G1, G2, G3, and so on of the flip-flops 87 are shifted and output for every clock signal.

On the other hand, image signals are serially input from the WR terminals of the electrode pads 7 to the light-emission-point controller 82.

When both of the input terminals of each AND gate 88 receive an H-level input signal (G+WR), the corresponding light emitting element 86 operates as follows. Specifically, as indicated as L1, L2, L3, and so on in FIG. 7, the light emitting elements 86 are turned on in accordance with the image signals sequentially from the first level. In other words, the light emitting elements 86 are turned on in accordance with the light-on rate of a predetermined image signal sequence. If the image signal sequence has a light-on rate of, for example, 100%, the light-emission-point array 81 sequentially turns on the entire group of light emitting elements 86. If the image signal sequence has a light-on rate of 25%, the light-emission-point array 81 turns on one or more of the light emitting elements 86 among the entire group thereof in accordance with the light-on rate.

In this state, the reference potential line extending from the VL terminals receives an electric current every time each of the light emitting elements 86 of the light-emission-point array 81 is turned on. Thus, the current limiting resistors 84 (indicated as RL in FIGS. 6 and 7) are supplied with electricity in accordance with the light-on rate of the light emitting elements 86, whereby the current limiting resistors 84 generate heat accordingly.

On the other hand, the heat generating source 85 (indicated as the resistor Rha in FIGS. 6 and 7) is connected to the second reference potential line 102 disposed in parallel with the reference potential line 101 extending from the VL terminals. Thus, the heat generating source 85 constantly generates heat by an electric power inversely proportional to the resistance value of the heat generating source.

In this example, the heat generating source 85 is a single heat generating source disposed in correspondence with the position including the center Oc in the first scanning direction of the light-emission-point array 81. In this case, the temperature distribution in the array direction of the light emitting elements 86 of the light-emission-point array 81 changes as shown in FIG. 5B. The temperature distribution shown in FIG. 5B is such that the temperature increases near the center in the first scanning direction of the light-emission-point array 81 due to the heat generated from the heat generating source 85. In this state, the ends of the light-emission-point array 81 in the first scanning direction have increased in temperature due to heat generated from the current limiting resistors 84. Therefore, the light-emission-point array 81 increases in temperature also near the center thereof in addition to the ends in the first scanning direction thereof. Accordingly, the temperature distribution in the first scanning direction of the light-emission-point array 81 assumedly reaches a state where the temperature difference has decreased, as compared with a case where the heat generating source 85 is not provided.

It is assumed that the light-on rate of the array of light emitting elements 86 of the light-emission-point array 81 is 100%. The temperature distribution in the array direction of the light emitting elements 86 of the light-emission-point array 81 changes as indicated with a solid line in FIG. 5B. The temperature distribution indicated with the solid line in FIG. 5B changes to a state where the temperature difference has decreased by ΔT100.

It is assumed that the light-on rate of the array of light emitting elements 86 of the light-emission-point array 81 is 25%. The temperature distribution in the array direction of the light emitting elements 86 of the light-emission-point array 81 changes as indicated with a dotted line in FIG. 5B. The temperature distribution indicated with the dotted line in FIG. 5B changes to a state where the temperature difference has decreased by ΔT25. In this example, the relationship ΔT100>ΔT25 with respect to the temperature difference is satisfied.

### First Comparative Embodiment

Next, a light emitting element chip U′ according to a first comparative embodiment will be described as an example for evaluating the performance of the light emitting element chip U according to the first exemplary embodiment.

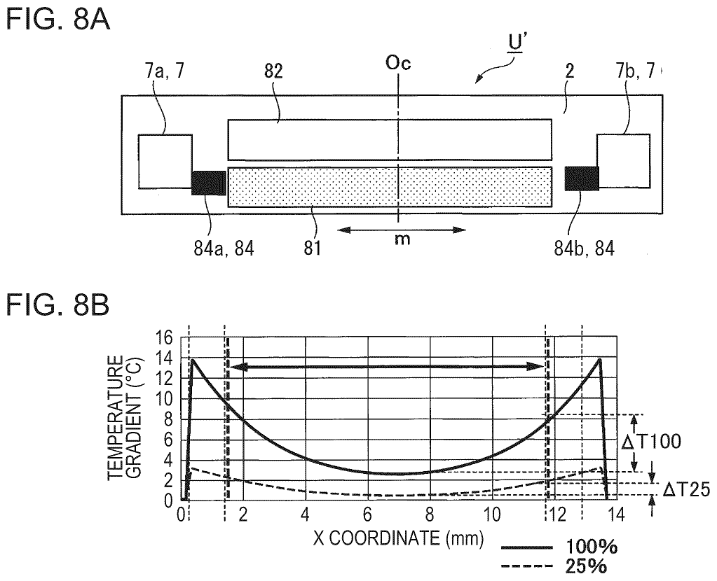

As shown in FIG. 8A, the light emitting element chip U′ according to the first comparative embodiment includes the substrate 2, the light-emission-point array 81, the light-emission-point controller 82, the electrode pads 7, and the current limiting resistors 84. Unlike the first exemplary embodiment, the light emitting element chip U does not include the heat generating source 85.

Therefore, in the light emitting element chip U′ according to the first comparative embodiment, the temperature distribution in the array direction of the light emitting elements 86 of the light-emission-point array 81 changes as shown in FIG. 8B. The temperature distribution shown in FIG. 8B has the shape of a quadratic curve in which the center in the first scanning direction is at the lowest and the opposite sides in the first scanning direction are high.

It is assumed that the light-on rate of the array of light emitting elements 86 of the light-emission-point array 81 is 100%. The temperature distribution in the array direction of the light emitting elements 86 of the light-emission-point array 81 changes as indicated with a solid line in FIG. 8B. The temperature distribution indicated with the solid line in FIG. 8B has a temperature difference ΔT100 that is greater than that in the first exemplary embodiment at the center and the opposite ends in the first scanning direction.

It is assumed that the light-on rate of the array of light emitting elements 86 of the light-emission-point array 81 is 25%. The temperature distribution in the array direction of the light emitting elements 86 of the light-emission-point array 81 changes as indicated with a dotted line in FIG. 8B. The temperature distribution indicated with the dotted line in FIG. 8B has a temperature difference ΔT25 that is greater than that in the first exemplary embodiment at the center and the opposite ends in the first scanning direction. In this example, the relationship ΔT100>ΔT25 with respect to the temperature difference is satisfied.

Accordingly, it is considered that the light emitting element chip U according to the first exemplary embodiment has higher performance than the light emitting element chip U′ according to the first comparative embodiment. Specifically, the light emitting element chip U according to the first exemplary embodiment may achieve a more uniform temperature distribution in the array direction of the light emitting elements 86 of the light-emission-point array 81.

### First Modification

In the first exemplary embodiment, the heat generating source 85 is configured to constantly generate heat in accordance with the electric power input to the current limiting resistors 84. However, if the electric power input to the current limiting resistors 84 is low, the temperature difference in the temperature distribution in the array direction of the light emitting elements 86 of the light-emission-point array 81 is smaller than in a case where the electric power input to the current limiting resistors 84 is high. For example, the electric power input to the current limiting resistors 84 increases and decreases dependently on the light-on rate of the light emitting elements 86 of the light-emission-point array 81. Thus, the electric power input to the current limiting resistors 84 decreases when the light-on rate of the light emitting elements 86 is low. In contrast, the electric power input to the current limiting resistors 84 increases when the light-on rate of the light emitting elements 86 is high.

Therefore, if there is a demand to minimize the heat generating effect of the heat generating source 85, the heat generating effect of the heat generating source 85 may be controlled in accordance with the electric power input to the current limiting resistors 84. In this case, a switching element may be series-connected to the heat generating source 85, and the electricity supplied to the heat generating source 85 may be controlled by switching the switching element. The heat generating source 85 may be configured to generate heat when the electric power input to the current limiting resistors 84 is equal to or higher than a predetermined threshold value and not generate heat when the electric power input to the current limiting resistors 84 is lower than the threshold value.

With regard to such a first modification, the design change may be similarly applied to second to fifth exemplary embodiments to be described below.

### Second Exemplary Embodiment

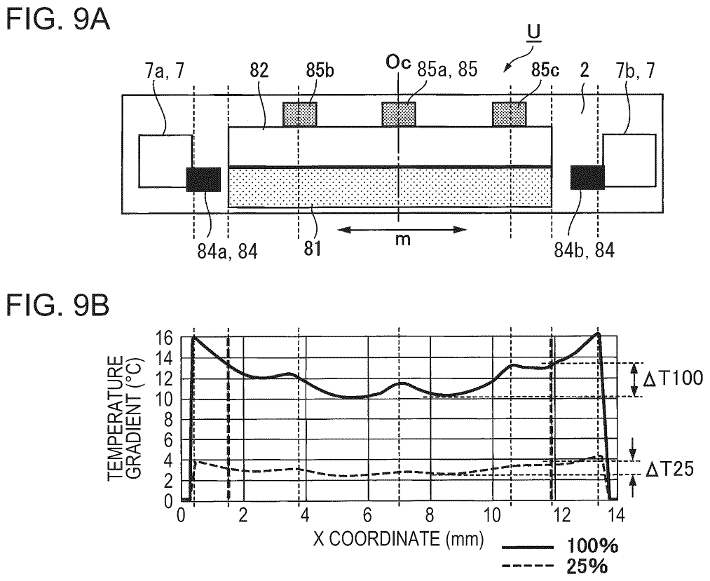

FIG. 9A illustrates a configuration example of a light emitting element chip according to a second exemplary embodiment.

In FIG. 9A, the basic configuration of the light emitting element chip U is substantially similar to that in the first exemplary embodiment, but differs from the first exemplary embodiment in terms of the installation state of the heat generating source 85. Components similar to those in the first exemplary embodiment will be given the same reference signs as in the first exemplary embodiment, and detailed descriptions thereof will be omitted here.

In this example, the heat generating source 85 is similar to that in the first exemplary embodiment in that it is provided at the substrate 2 at a position located parallel to the first scanning direction of the light-emission-point array 81. However, in this example, the heat generating source 85 is constituted of multiple (three in this example) resistance elements.

A first heat generating source 85a (85) is disposed at a position including the center Oc in the first scanning direction of the light-emission-point array 81. A second heat generating source 85b and a third heat generating source 85c are disposed symmetrically with respect to the center Oc in the first scanning direction of the light-emission-point array 81. In this example, the second heat generating source 85b and the third heat generating source 85c are disposed toward the ends of the light-emission-point array 81 in the first scanning direction. For example, the positions of the second heat generating source 85b and the third heat generating source 85c may be appropriately selected within a range of ⅔ to ¾ from the center in the region extending from the center toward the ends of the light-emission-point array 81.

In this example, the heat quantities generated from the first heat generating source 85a to the third heat generating source 85c are selected as follows.

The heat quantity from the first heat generating source 85a is appropriately selected within a range of, for example, 0.4 times to 0.6 times (0.5 times in this example) the heat value dependent on the electric power input to the current limiting resistors 84.

The heat quantity from the second heat generating source 85b is appropriately selected within a range of, for example, 0.3 times to 0.5 times (0.4 times in this example) the heat value dependent on the electric power input to the current limiting resistors 84.

The heat quantity from the third heat generating source 85c is selected similarly to the second heat generating source 85b.

In particular, in this example, the allocation of the heat quantity generated from the first heat generating source 85a is greater than those of the second heat generating source 85b and the third heat generating source 85c. Such allocation of the heat quantity is effective for suppressing a variation difference in the temperature distribution in the first scanning direction of the light-emission-point array 81. It is also possible to allocate the heat quantities substantially equally to all of the heat generating sources 85a to 85c or to allocate greater heat quantities to the second heat generating source 85b and the third heat generating source 85c than the first heat generating source 85a. However, in these cases, it is to be taken into consideration that, in the temperature distribution, the temperature tends to increase excessively at the ends of the light-emission-point array 81 in the first scanning direction.

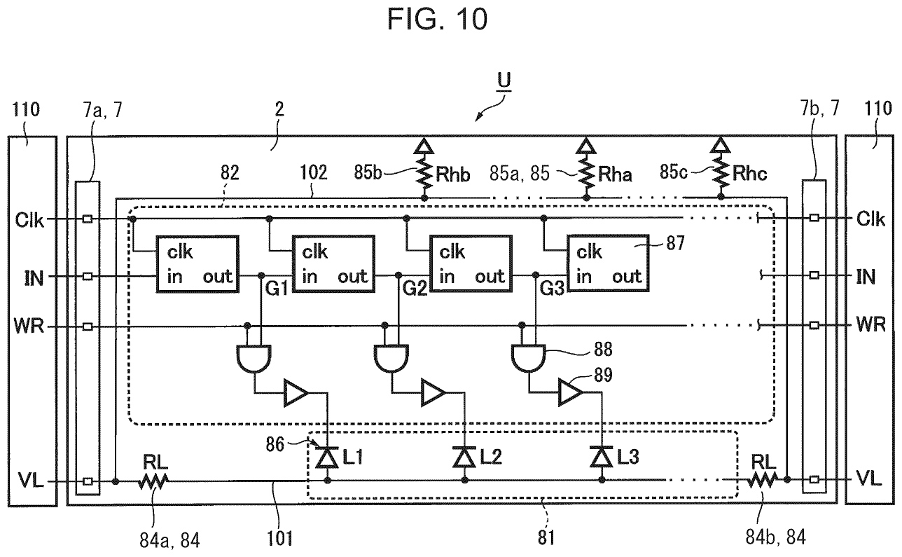

FIG. 10 illustrates a circuit configuration example of the light emitting element chip used in the second exemplary embodiment.

In FIG. 10, the circuit configuration of the light emitting element chip U includes components substantially similar to those in the first exemplary embodiment except for the heat generating sources 85 (85a to 85c).

In this example, the heat generating sources 85 (85a to 85c) are connected to the second reference potential line 102 disposed in parallel with the reference potential line 101 extending from the VL terminals of the electrode pads 7. The first heat generating source 85a is connected near the center of the second reference potential line 102. The second heat generating source 85b and the third heat generating source 85c are disposed symmetrically with respect to the center of the second reference potential line 102. In this example, the reference potential line 101 and the second reference potential line 102 are supplied with electricity at the light emission timing of each light emitting element 86.

### Actuation of Light Emitting Element Chip

The basic operation of the light emitting element chip U is substantially similar to that in the first exemplary embodiment.

The reference potential line 101 extending from the VL terminals receive an electric current every time each of the light emitting elements 86 of the light-emission-point array 81 is turned on. Thus, the current limiting resistors 84 (indicated as RL in FIG. 10) are supplied with electricity in accordance with the light-on rate of the light emitting elements 86, whereby the current limiting resistors 84 generate heat accordingly.

On the other hand, the heat generating sources 85 (85a to 85c indicated as resistors Rha to Rhc in FIG. 10) are connected to the second reference potential line 102 disposed in parallel with the reference potential line 101 extending from the VL terminals. Thus, each of the heat generating sources 85 (85a to 85c) generates heat by an electric power inversely proportional to the resistance value of the heat generating source.

In this example, the heat generating sources 85 are multiple (three in this example) heat generating sources disposed in correspondence with a position near the center Oc in the first scanning direction of the light-emission-point array 81 and symmetrical positions with respect to the center. The allocation of the heat quantity generated from the first heat generating source 85a (Rha) is selected such that the heat quantity therefrom is slightly greater than the heat quantities generated from the second heat generating source 85b (Rhb) and the third heat generating source 85c (Rhc). When the heat value of the current limiting resistors 84 is defined as 1, the heat quantity from the first heat generating source 85a is, for example, 0.5 and the heat quantity from each of the second heat generating source 85b and the third heat generating source 85c is, for example, 0.4.

In this case, the temperature distribution in the array direction of the light emitting elements 86 of the light-emission-point array 81 changes as shown in FIG. 9B. The temperature distribution shown in FIG. 9B is such that the temperature increases near the center Oc and the ends of the light-emission-point array 81 in the first scanning direction due to the heat generated from the three heat generating sources 85. In particular, in this example, the heat quantity from each of the second heat generating source 85b and the third heat generating source 85c is selected to be smaller than the heat quantity from the first heat generating source 85a. Thus, there is no concern of an excessive increase in the temperature near the ends of the light-emission-point array 81 in the first scanning direction.

It is assumed that the light-on rate of the array of light emitting elements 86 of the light-emission-point array 81 is 100%. The temperature distribution in the array direction of the light emitting elements 86 of the light-emission-point array 81 changes as indicated with a solid line in FIG. 9B. The temperature distribution indicated with the solid line in FIG. 9B changes to a state where the temperature difference has decreased by ΔT100.

It is assumed that the light-on rate of the array of light emitting elements 86 of the light-emission-point array 81 is 25%. The temperature distribution in the array direction of the light emitting elements 86 of the light-emission-point array 81 changes as indicated with a dotted line in FIG. 9B. The temperature distribution indicated with the dotted line in FIG. 9B changes to a state where the temperature difference has decreased by ΔT25. In this example, the relationship ΔT100>ΔT25 with respect to the temperature difference is satisfied.

With regard to the temperature differences ΔT100 and ΔT25, a comparison between the second exemplary embodiment and the first exemplary embodiment indicates that both temperature differences are reduced more in the second exemplary embodiment.

### Third Exemplary Embodiment

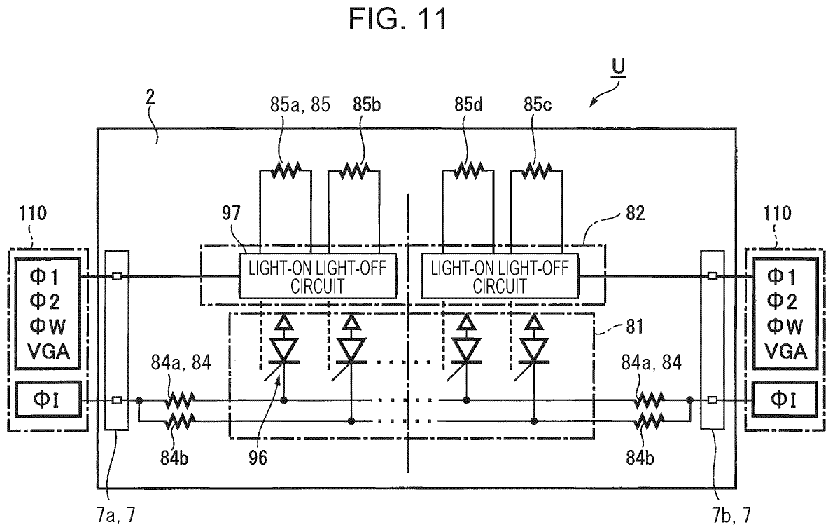

FIG. 11 illustrates a configuration example of a light emitting element chip according to a third exemplary embodiment.

In FIG. 11, the basic configuration of the light emitting element chip U is substantially similar to that in the first exemplary embodiment. In detail, the light emitting element chip U includes the substrate 2, the light-emission-point array 81, the light-emission-point controller 82, the electrode pads 7, the current limiting resistors 84, and the heat generating sources 85.

In this example, the light-emission-point array 81 has light emitting elements 96 that are different from those in the first and second exemplary embodiments and that are arranged in an array along the long edges of the substrate 2. In this example, the array direction of the light emitting elements 96 is also treated as the first scanning direction.

The light-emission-point controller 82 includes a light-on light-off circuit 97 that performs light-on and light-off control on the light emitting elements 96.

In this example, the light-emission-point controller 82 performs light-on and light-off control concurrently on odd-numbered arrays of light emitting elements 96 and even-numbered arrays of light emitting elements 96 among the light emitting elements 96.

Furthermore, the electrode pads 7 input various control signals to the light-emission-point array 81 and the light-emission-point controller 82.

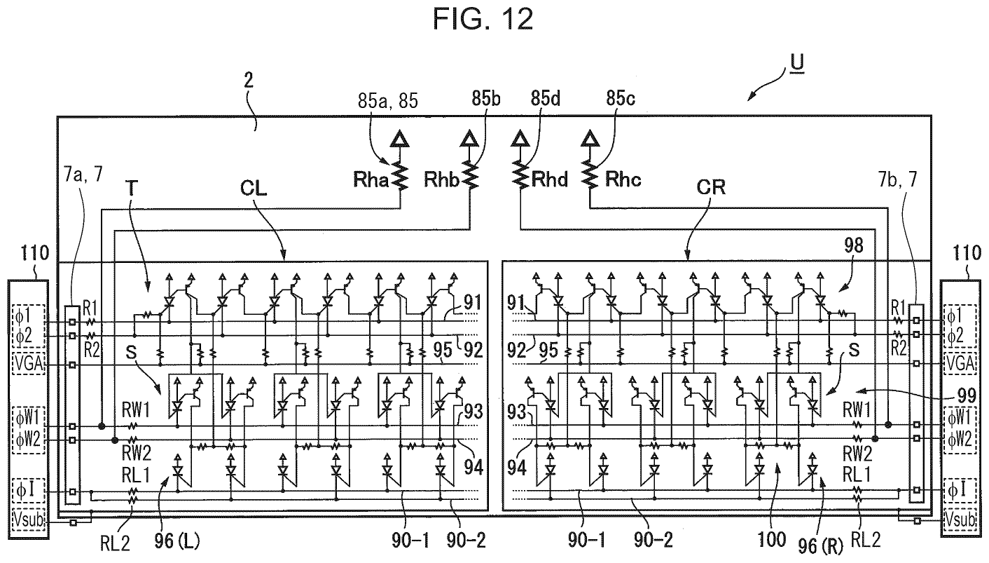

In this example, the electrode pads 7 are provided as a pair at the opposite ends of the substrate 2 in the first scanning direction. Similar to the first exemplary embodiment, the pair of electrode pads 7 input control signals dividedly to the light emitting elements 96 of the light-emission-point array 81 and the light-on light-off circuit 97 of the light-emission-point controller 82. Specifically, in this example, the light emitting element chip U is constituted of two divided chip sections CL and CR (see FIG. 12) that are divided into left and right sections with the center of the substrate 2 in the first scanning direction interposed therebetween.

The current limiting resistors 84 are provided as a set at each of the opposite sides of the light-emission-point array 81 in the first scanning direction. In this example, the odd-numbered arrays and the even-numbered arrays of light emitting elements 96 are processed concurrently. Therefore, two first current limiting resistors 84a are provided in correspondence with a group of odd-numbered arrays of light emitting elements 96. Two second current limiting resistors 84b are provided in correspondence with a group of even-numbered arrays of light emitting elements 96.

Furthermore, similar to the second exemplary embodiment, multiple heat generating sources 85 are provided at positions of the substrate 2 located parallel to the first scanning direction of the light-emission-point array 81. In this example, the heat generating sources 85 are constituted of multiple (four in this example) resistance elements. The multiple heat generating sources 85 (i.e., 85a to 85d) include two heat generating sources and two heat generating sources that are disposed symmetrically with respect to the center Oc in the first scanning direction of the light-emission-point array 81. In this example, the first heat generating source 85a and the second heat generating source 85b are disposed at positions that substantially trisect a region located leftward relative to the center Oc in the first scanning direction of the light-emission-point array 81. The third heat generating source 85c and the fourth heat generating source 85d are disposed at positions that substantially trisect a region located rightward of the center Oc in the first scanning direction of the light-emission-point array 81. In this example, the first heat generating source 85a and the third heat generating source 85c are disposed toward the ends of the light-emission-point array 81 in the first scanning direction.

### Each Element of Light Emitting Element Chip

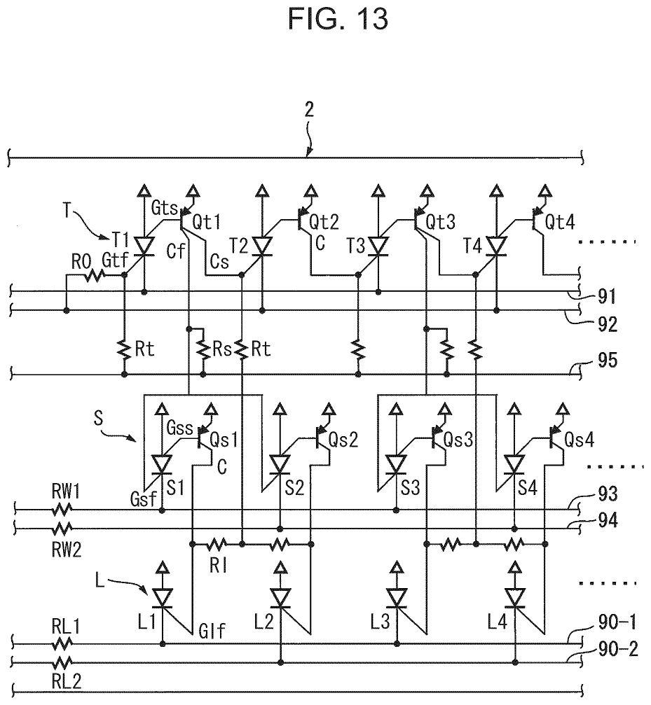

FIG. 12 illustrates a circuit configuration example of the light emitting element chip according to the third exemplary embodiment. FIG. 13 is a partially enlarged view of FIG. 12. Electrode Pad

In this example, as shown in FIG. 12, each electrode pad 7 includes terminals corresponding to a φ1 terminal, a φ2 terminal, a φW terminal, a VGA terminal, and a φI terminal of the signal generating circuit 110.

### Light-Emission-Point Array

In FIGS. 12 and 13, the light-emission-point array 81 has the light emitting elements 96 constituted of light emitting thyristors that are arranged in the first scanning direction. Specifically, the light-emission-point array 81 includes a light emitting thyristor array having sequentially-arranged light emitting thyristors L (L1, L2, L3, and so on) as the light emitting elements 96. In this example, unlike LEDs, the light emitting thyristors L are simple in that the light-emission-point array 81 and the light-emission-point controller 82 may both be constituted of thyristors.

In this example, each of the light emitting thyristors L is a semiconductor element having a first gate, a second gate, an anode, and a cathode. In this example, the cathodes of odd-numbered light emitting thyristors L1, L3, L5, and so on are connected to a light-on signal line 90-1. The light-on signal line 90-1 is connected to the φ1 terminals via the current limiting resistors 84 (84a). In FIGS. 12 and 13, each of the current limiting resistors 84 (84a) is indicated as RL1.

On the other hand, the cathodes of even-numbered light emitting thyristors L2, L4, L6, and so on are connected to a light-on signal line 90-2. In this example, the light-on signal line 90-2 is connected in parallel with the light-on signal line 90-1. The light-on signal line 90-2 is connected to the φ1 terminals via the current limiting resistors 84 (84b). A light-on signal φI is transmitted to each φI terminal. In FIGS. 12 and 13, each of the current limiting resistors 84 (84b) is indicated as RL2.

### Light-Emission-Point Controller

In this example, the light-emission-point controller 82 includes the light-on light-off circuit 97 mentioned above. The light-on light-off circuit 97 includes a transfer thyristor array 98 and a write thyristor array 99.

The transfer thyristor array 98 includes transfer thyristors T (T1, T2, T3, and so on) that are arranged in an array, similarly to a light emitting thyristor array 100.

In this example, the transfer thyristor array 98 has every two of the transfer thyristors T1, T2, T3, and so on set as a pair in numerical order. The transfer thyristor array 98 includes coupling transistors Qt1, Qt2, Qt3, and so on as pnp bipolar transistors between the pairs.

On the other hand, the write thyristor array 99 is similar to the light emitting thyristor array 100 in being constituted of write thyristors S1, S2, S3, and so on arranged in an array. The write thyristor array 99 includes write thyristors Qs1, Qs2, Qs3, and so on in correspondence with the write thyristors S1, S2, S3, and so on.

The surface of the substrate 2 is provided with a first transfer signal line 91 that transmits a first transfer signal φ1 and a second transfer signal line 92 that transmits a second transfer signal φ2. The first transfer signal line 91 and the second transfer signal line 92 are respectively series-connected to current limiting resistors R1 and R2 that prevent excessive electric current from flowing therethrough.

Furthermore, the surface of the substrate 2 is provided with a first write signal line 93 that transmits a first write signal φW1 and a second write signal line 94 that transmits a second write signal φW2. The first write signal line 93 and the second write signal line 94 are respectively series-connected to current limiting resistors RW1 and RW2 that prevent excessive electric current from flowing therethrough.

Similar to the light emitting thyristors L, each of the transfer thyristors T and the write thyristors S is a semiconductor element having a first gate, a second gate, an anode, and a cathode. Although each of the coupling transistors Qt and the write transistors Qs is a semiconductor element having a collector, a base, and an emitter, each of the odd-numbered coupling transistors Qt has two collectors (multi-collectors).

Referring to FIGS. 12 and 13, the first gate and the second gate of each transfer thyristor T are indicated as Gtf and Gts, respectively, the first gate and the second gate of each write thyristor S are indicated as Gsf and Gss, respectively, and the first gate of each light emitting thyristor L is indicated as Glf. Likewise, the first collector and the second collector of each of the odd-numbered multi-collector coupling transistors Qt are indicated as Cf and Cs, respectively, and the collector of each of the even-numbered coupling transistors Qt is indicated as C. The collector of each write transistor Qs is indicated as C.

Next, an electrical connection of elements in each of the transfer thyristor array 98 and the write thyristor array 99 will be described (see FIGS. 12 and 13).

### Transfer Thyristor Array

The anode of each transfer thyristor T, the anode of each write thyristor S, and the anode of each light emitting thyristor L are connected to the substrate 2. The emitter of each coupling transistor Qt and the emitter of each write transistor Qs are also connected to the substrate 2.

These anodes and emitters are connected to a power supply line (not shown) via back electrodes serving as Vsub terminals provided at the back surface of the substrate 2. This power supply line is supplied with a reference potential Vsub from a reference potential supplier (not shown).

The cathodes of the odd-numbered transfer thyristors T1, T3, T5, and so on are connected to the first transfer signal line 91 along the transfer thyristor array 98. The first transfer signal line 91 is connected to the φ1 terminal via the current limiting resistor R1. The φ1 terminal is connected to a first transfer signal line (not shown), and a first transfer signal φ1 is transmitted to the φ1 terminal.

The cathodes of the even-numbered transfer thyristors T2, T4, T6, and so on are connected to the second transfer signal line 92 along the transfer thyristor array 98. The second transfer signal line 92 is connected to the φ2 terminal via the current limiting resistor R2. The φ2 terminal is connected to a second transfer signal line (not shown), and a second transfer signal φ2 is transmitted to the φ2 terminal.

Furthermore, the first gate Gtf of each odd-numbered transfer thyristor T is connected to a power supply line 95 via a resistor Rt along the transfer thyristor array 98. The second gate Gts is connected to the base of the corresponding odd-numbered coupling transistor Qt. The power supply line 95 is connected to the VGA terminal.

The first collector Cf of each odd-numbered coupling transistor Qt is connected to the power supply line 95 via a resistor Rs. Each odd-numbered first collector Cf is connected to the first gate Gsf of the corresponding odd-numbered write thyristor S with the same number and to the first gate Gsf of the corresponding even-numbered write thyristor S with a number larger by 1. The second collector Cs is connected to the first gate Gtf of the corresponding even-numbered (subsequent-stage) transfer thyristor T with a number larger by 1.

The first gate Gtf of each even-numbered transfer thyristor T is connected to the power supply line 95 via the corresponding resistor Rt. The second gate Gts is connected to the base of the corresponding even-numbered coupling transistor Qt. The collector C of each even-numbered coupling transistor Qt is connected to the first gate Gtf of the corresponding odd-numbered (subsequent-stage) transfer thyristor T with a number larger by 1.

### Write Thyristor Array

The cathodes of the odd-numbered write thyristors S are connected to the first write signal line 93 along the write thyristor array 99. The first write signal line 93 is connected to a φW1 terminal via the current limiting resistor RW1. The φW1 terminal is connected to a write signal line (not shown), and the first write signal φW1 is transmitted to the φW1 terminal.

The cathodes of the even-numbered write thyristors S are connected to the second write signal line 94 along the write thyristor array 99. The second write signal line 94 is connected to a φW2 terminal via the current limiting resistor RW2. The φW2 terminal is connected to the write signal line (not shown), and the second write signal φW2 is transmitted to the φW2 terminal.

A second gate Gss of each write thyristor S is connected to the base of the write transistor Qs provided in correspondence therewith. The collector C of each write transistor Qs is connected to the power supply line 95 via the resistor R1, and is also connected to a first gate Glf of the light emitting thyristor L of the same number.

As mentioned above, in the light emitting element chip U according to the third exemplary embodiment, each odd-numbered transfer thyristor T is connected to the write thyristor S with the same number and to the write thyristor S with a number larger by 1, and each write thyristor S is connected to the corresponding light emitting thyristor L. Specifically, two light emitting thyristors L are controlled by the corresponding odd-numbered transfer thyristor T.

As an alternative to being a multi-connector, each odd-numbered coupling transistor Qt may have one collector and may be connected mutually to the first gate Gsf of the corresponding write thyristor S and the first gate Gtf of the corresponding transfer thyristor T.

### Heat Generating Sources

In this example, there are four heat generating sources 85 provided.

In FIG. 12, the first heat generating source 85a to the fourth heat generating source 85d are indicated as Rha, Rhb, Rhc, and Rhd, respectively.

In this example, the first heat generating source 85a and the third heat generating source 85c are disposed toward the ends of the light-emission-point array 81 in the first scanning direction. The second heat generating source 85b and the fourth heat generating source 85d are disposed toward the center in the first scanning direction of the light-emission-point array 81.

The first heat generating source 85a and the third heat generating source 85c are connected to the first write signal line 93. The second heat generating source 85b and the fourth heat generating source 85d are connected to the second write signal line 94.

The heat quantities of the first heat generating source 85a to the fourth heat generating source 85d may be appropriately selected. In this example, when the heat value of the current limiting resistor 84 (RL1 or RL2) is defined as 1, the heat quantity from each of the first heat generating source 85a and the third heat generating source 85c is selected to be 0.4, and the heat quantity from each of the second heat generating source 85b and the fourth heat generating source 85d is selected to be 0.5.

### Actuation of Light Emitting Element Chip

In this example, the light emitting elements 96 of the light-emission-point array 81 undergo light-on control and light-off control performed by the light-on light-off circuit 97 of the light-emission-point controller 82. Therefore, in this example, the light emitting elements 96 of the light-emission-point array 81 repeatedly and sequentially undergo a light-on operation and a light-off operation concurrently between the odd-numbered array group and the even-numbered array group.

In this state, when the odd-numbered arrays of light emitting elements 96 are to be turned on, the light-on signal line 90-1 and the first write signal line 93 are supplied with electricity. Thus, electric current flows through the current limiting resistor 84a (RL1) connected to the light-on signal line 90-1, whereby heat is generated. Moreover, electric current flows through the first heat generating source 85a (Rha) and the third heat generating source 85c (Rhc) that are connected to the first write signal line 93, whereby heat is generated.

When the even-numbered arrays of light emitting elements 96 are to be turned on, the light-on signal line 90-2 and the second write signal line 94 are supplied with electricity. Thus, electric current flows through the current limiting resistor 84b (RL2) connected to the light-on signal line 90-2, whereby heat is generated. Moreover, electric current flows through the second heat generating source 85b (Rhb) and the fourth heat generating source 85d (Rhd) that are connected to the second write signal line 94, whereby heat is generated.

In this example, the temperature distribution in the array direction of the light emitting elements 96 of the light-emission-point array 81 is such that the temperature increases near the center and the ends of the light-emission-point array 81 in the first scanning direction due to the heat generated from the four heat generating sources 85 (85a to 85d). In particular, in this example, the heat quantity from each of the heat generating sources 85 (85a and 85c) located toward the ends of the light-emission-point array 81 in the first scanning direction is selected to be smaller than the heat quantity from each of the heat generating sources 85 (85b and 85d) located toward the center. Thus, there is no concern of an excessive increase in the temperature near the ends of the light-emission-point array 81 in the first scanning direction.

The temperature distribution in the array direction of the light emitting elements 96 of the light-emission-point array 81 changes to a state where the temperature difference ΔT has decreased, as compared with a case where the heat generating sources 85 are not provided.

This situation is more noticeable as the light-on rate of the array of light emitting elements 96 of the light-emission-point array 81 becomes higher.

### Fourth Exemplary Embodiment

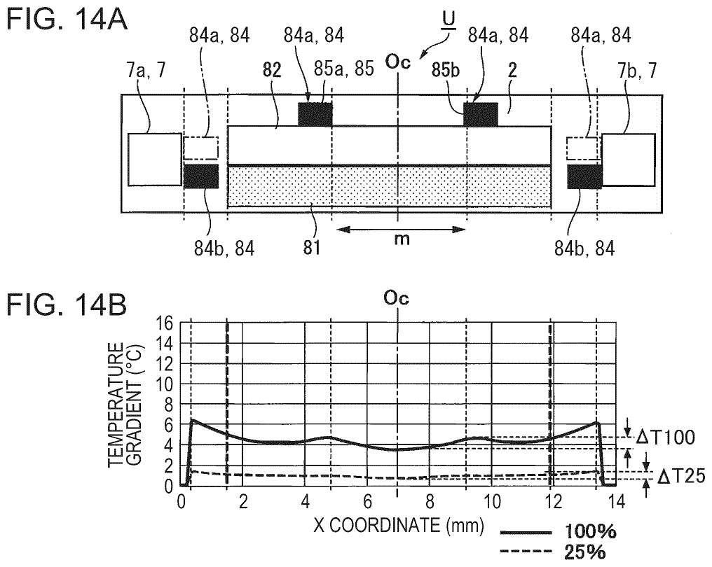

FIG. 14A illustrates the relevant part of a light emitting element chip according to a fourth exemplary embodiment.

In FIG. 14A, the basic configuration of the light emitting element chip U is substantially similar to that in the third exemplary embodiment. In detail, the light emitting element chip U includes the substrate 2, the light-emission-point array 81, the light-emission-point controller 82, the electrode pads 7, and the current limiting resistors 84.

However, the light emitting element chip U according to this example includes heat generating sources 85 that are different from those in the first to third exemplary embodiments.

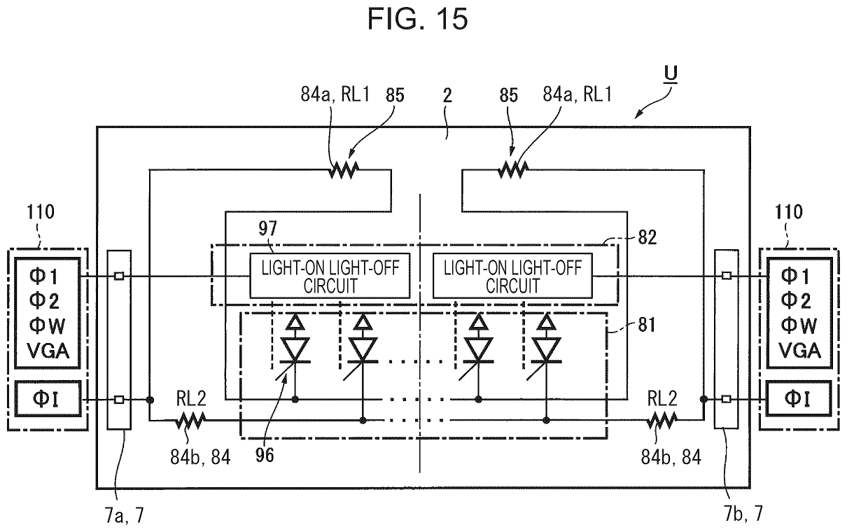

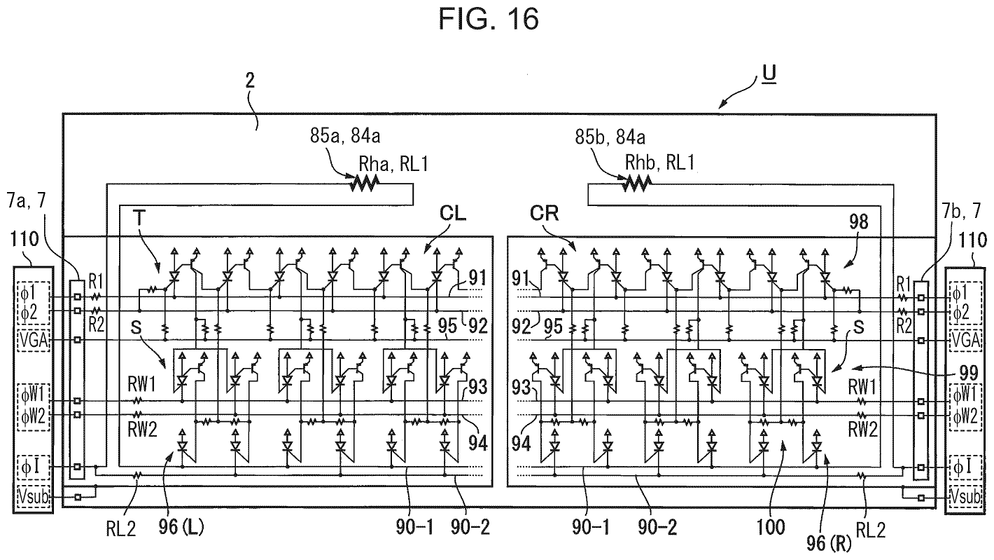

In this example, as shown in FIGS. 14A to 16, there are provided two sets of current limiting resistors 84 that limit the electric power supplied to the odd-numbered arrays and the even-numbered arrays of light emitting elements 96 of the light-emission-point array 81. The current limiting resistors 84 (84a) of the first set are disposed in correspondence with the odd-numbered arrays of light emitting elements 96 of the light-emission-point array 81. The current limiting resistors 84 (84b) of the second set are disposed in correspondence with the even-numbered arrays of light emitting elements 96 of the light-emission-point array 81. In FIG. 16, the current limiting resistors 84a are each indicated as RL1, and the current limiting resistors 84b are each indicated as RL2.

In this example, the heat generating sources 85 are configured to also serve as some of the current limiting resistors 84. In detail, the heat generating sources 85 also serve as the first set of current limiting resistors RL1 (84a) and have been changed to positions different from the ends of the light-emission-point array 81 in the first scanning direction. In this example, the heat generating sources 85 may be such that the current limiting resistors 84a (RL1) of the first set are changed to positions located parallel to the first scanning direction of the light-emission-point array 81. In this example, the first set of current limiting resistors RL1 also serving as the heat generating sources 85 may be disposed symmetrically with respect to the center Oc in the first scanning direction of the light-emission-point array 81. For example, one of the current limiting resistors 84a (RL1) is disposed at a position that substantially bisects a region located leftward of the center Oc in the first scanning direction of the light-emission-point array 81. The other current limiting resistor 84a (RL1) is disposed at a position that substantially bisects a region located rightward of the center Oc in the first scanning direction of the light-emission-point array 81.

In this example, the positional relationship between the current limiting resistors RL1 (84a) is changed from the original positions thereof. However, the current limiting resistors (RL1) 84a are to be series-connected to the light-on signal line 90-1.

In FIG. 16, the current limiting resistors RL1 also serving as the heat generating sources 85 are indicated as two heat generating sources 85a and 85b (Rha and Rhb).

As an alternative to this example in which the heat generating sources 85 also serve as the first set of current limiting resistors RL1, the heat generating sources 85 may also serve as the second set of current limiting resistors RL2.

### Actuation of Light Emitting Element Chip

In this example, the heat generating sources 85 are configured to also serve as the current limiting resistors 84a (RL1). In this example, the ends of the light-emission-point array 81 in the first scanning direction are heated in accordance with the heat generated by the current limiting resistors RL2. On the other hand, the areas near where the heat generating sources 85 are disposed with the center Oc, in the first scanning direction of the light-emission-point array 81, interposed therebetween are heated in accordance with the heat generated by the heat generating sources 85 also serving as the current limiting resistors RL1.

In this case, the current limiting resistors RL1 also serving as the heat generating sources 85 are disposed in areas located away from the ends of the light-emission-point array 81 in the first scanning direction. Thus, the ends of the light-emission-point array 81 in the first scanning direction are not excessively heated in accordance with the heat generated by the current limiting resistors RL1.

It is assumed that the light-on rate of the array of light emitting elements 96 of the light-emission-point array 81 is 100%. The temperature distribution in the array direction of the light emitting elements 96 of the light-emission-point array 81 changes as indicated with a solid line in FIG. 14B. The temperature distribution indicated with the solid line in FIG. 14B changes to a state where the temperature difference has decreased by ΔT100.

It is assumed that the light-on rate of the array of light emitting elements 96 of the light-emission-point array 81 is 25%. The temperature distribution in the array direction of the light emitting elements 96 of the light-emission-point array 81 changes as indicated with a dotted line in FIG. 14B. The temperature distribution indicated with the dotted line in FIG. 14B changes to a state where the temperature difference has decreased by ΔT25.

In this example, the relationship ΔT100>ΔT25 with respect to the temperature difference is satisfied.

Furthermore, in this example, the current limiting resistors RL1 also serving as the heat generating sources 85 hardly heat near the ends of the light-emission-point array 81 in the first scanning direction.

Therefore, in this example, a temperature increase near the ends of the light-emission-point array 81 in the first scanning direction assumedly decreases due to not being affected by the heat value of the current limiting resistors RL1.

### Fifth Exemplary Embodiment

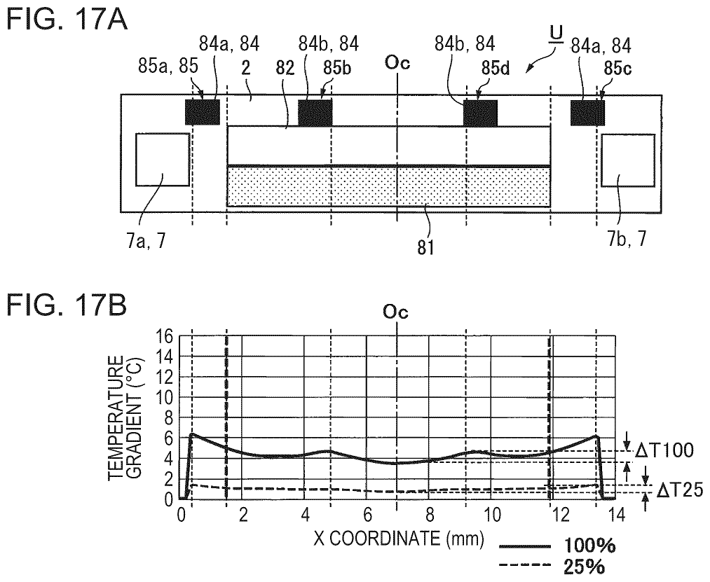

FIG. 17A illustrates the relevant part of a light emitting element chip according to a fifth exemplary embodiment.

In FIG. 17A, the basic configuration of the light emitting element chip U is substantially similar to that in the fourth exemplary embodiment. In detail, the light emitting element chip U includes the substrate 2, the light-emission-point array 81, the light-emission-point controller 82, the electrode pads 7, and the current limiting resistors 84.

However, unlike the fourth exemplary embodiment, the heat generating sources 85 in the light emitting element chip U according to this example also serve as all of the current limiting resistors 84.

Specifically, in this example, the current limiting resistors 84 are not disposed at the ends of the light-emission-point array 81 in the first scanning direction.

In this example, the heat generating sources 85 also serve as all of the current limiting resistors 84 (84a and 84b) and are changed to positions located parallel to the first scanning direction of the light-emission-point array 81. In this example, there are four heat generating sources 85 provided. In this example, the four heat generating sources 85 (85a to 85d) are disposed symmetrically with respect to the center Oc in the first scanning direction of the light-emission-point array 81. More specifically, the first heat generating source 85a and the third heat generating source 85c are provided at positions that are located in regions outward of the ends of the light-emission-point array 81 in the first scanning direction and that are located away from the ends in the second scanning direction. In contrast, the second heat generating source 85b and the fourth heat generating source 85d are provided at positions that substantially bisect the center and the ends of the light-emission-point array 81 in the first scanning direction.

In this example, the ends of the light-emission-point array 81 in the first scanning direction are not directly heated in accordance with the heat generated by the current limiting resistors 84 (RL). The current limiting resistors RL1 (84a) and RL2 (84b) also serving as the heat generating sources 85 apply heat substantially uniformly from the positions located parallel to the first scanning direction of the light-emission-point array 81.

It is assumed that the light-on rate of the array of light emitting elements 96 of the light-emission-point array 81 is 100%. The temperature distribution in the array direction of the light emitting elements 96 of the light-emission-point array 81 changes as indicated with a solid line in FIG. 17B. The temperature distribution indicated with the solid line in FIG. 17B changes to a state where the temperature difference has decreased by ΔT100.

It is assumed that the light-on rate of the array of light emitting elements 96 of the light-emission-point array 81 is 25%. The temperature distribution in the array direction of the light emitting elements 96 of the light-emission-point array 81 changes as indicated with a dotted line in FIG. 17B. The temperature distribution indicated with the dotted line in FIG. 17B changes to a state where the temperature difference has decreased by ΔT25. In this example, the relationship ΔT100>ΔT25 with respect to the temperature difference is satisfied.

### PRACTICAL EXAMPLES

### First Practical Example

A first practical example is a realization of the light emitting element chip according to the first exemplary embodiment (in which a single heat generating source is used). With regard to the size of the light emitting element chip in this example, the dimension in the x direction is about 14 mm, and the dimension in the y direction is about 0.4 mm.

### Second Practical Example

A second practical example is a realization of the light emitting element chip according to the second exemplary embodiment (in which three heat generating sources are used). In this example, the light emitting element chip has the same size as in the first practical example.

### Third Practical Example

A third practical example is a realization of the light emitting element chip according to the fourth exemplary embodiment (in which two heat generating sources also serve as current limiting resistors). In this example, the light emitting element chip has the same size as in the first practical example.

### Fourth Practical Example

A fourth practical example is a realization of the light emitting element chip according to the fifth exemplary embodiment (in which four heat generating sources also serve as current limiting resistors). In this example, the light emitting element chip has the same size as in the first practical example.

### First Comparative Example

A first comparative example is a realization of the light emitting element chip according to the first comparative embodiment (in which heat sources are not used). With regard to the size of the light emitting element chip in this example, the dimension in the x direction is about 14 mm, and the dimension in the y direction is about 0.39 mm.

### Characteristic Verification of Light Emitting Element Chip According to First Comparative Example

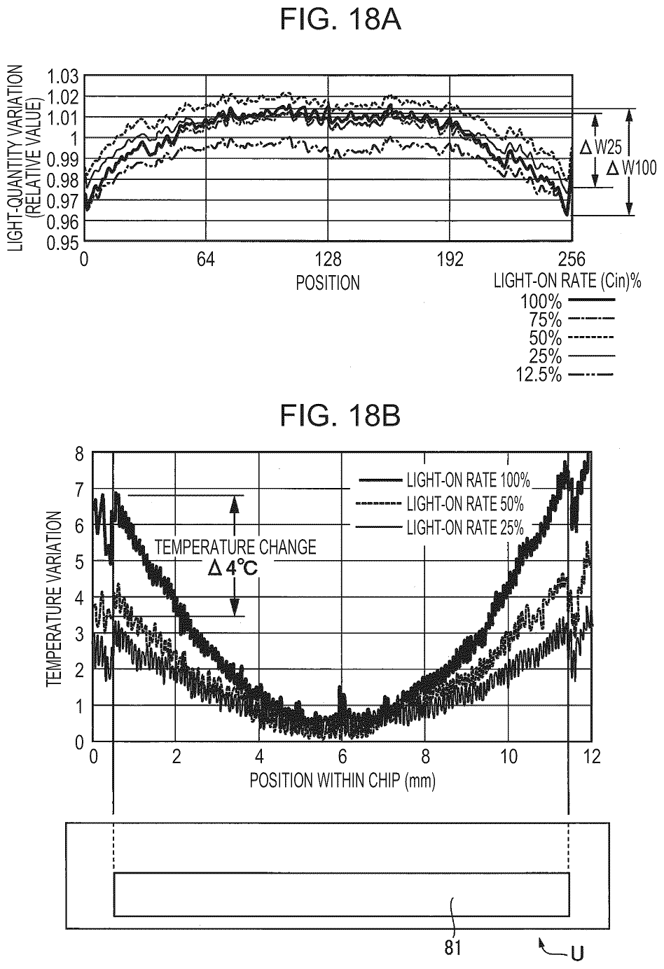

After measuring the light-quantity variation characteristic and the temperature distribution characteristic in the first scanning direction of the light emitting element chip according to the first comparative example, the results shown in FIGS. 18A and 18B are obtained.

FIG. 18A illustrates the verification of the light-quantity variation characteristic in the first scanning direction of the light emitting element chip according to the first comparative example.

In FIG. 18A, a light-on rate (Cin) of the light emitting elements of the light emitting element chip is changed, and the light-quantity variation of the light emitting element chip is measured for every light-on rate. Examples of the light-on rate (Cin) shown include 100%, 75%, 50%, 25%, and 12.5%. In FIG. 18A, the abscissa axis denotes a position of the light emitting element chip in the first scanning direction, whereas the ordinate axis denotes a relative light quantity with 1 as a reference light quantity.

FIG. 18B illustrates the verification of a temperature variation characteristic in the first scanning direction of the light emitting element chip according to the first comparative example.

In FIG. 18B, the light-on rate (Cin) of the light emitting elements of the light emitting element chip is changed, and the temperature variation of the light emitting element chip is measured for every light-on rate. Examples of the light-on rate (Cin) shown include 100%, 50%, and 25%. In FIG. 18B, the abscissa axis denotes a position of the light emitting element chip in the first scanning direction, whereas the ordinate axis denotes a temperature variation value with the lowest temperature location of the light emitting element chip as a reference (0).

First, according to FIG. 18B, it is ascertained that the temperature distribution of the light emitting element chip in the first scanning direction changes in the form of a quadratic curve with the area near the center as a minimum. In this case, it is apparent that the temperature variation of the light emitting element chip increases with increasing light-on rate. It is also apparent that the temperature difference in the light emitting element chip has changed by about 4° C. due to different light-on rates.

According to FIG. 18A, it is ascertained that the light-quantity variation of the light emitting element chip increases with increasing light-on rate. For example, a light-quantity difference ΔW100 is 4.5% when the light-on rate is 100%, and a light-quantity difference ΔW25 is 3.5% when the light-on rate is 25%.

Accordingly, in the light emitting element chip, it is apparent that the temperature and the light quantity are dependent on each other. In this example, the light quantity decreases in areas where the temperature of the light emitting element chip is high, so that the light-quantity difference in the light emitting element chip changes by about 1% in accordance with a change in the light-on rate (e.g., between 100% and 25%). Normally, in the light emitting element chip, it is known that an internal quantum efficiency of a light emission point constituted of a light emitting element decreases as the temperature increases. A light-quantity temperature coefficient of this type is, for example, about −0.2%/° C.

Subsequently, after measuring the temperature difference in the temperature distribution of the light-emission-point array in the light emitting element chip according to each of the first to fourth practical examples and the first comparative example, results shown in Table are obtained.

In Table, ΔT100 indicates a temperature difference when the light-on rate is 100%, ΔT25 indicates a temperature difference when the light-on rate is 25%, and ΔT100−25 indicates a difference between ΔT100 and ΔT25.

According to Table, it is apparent that, in the first to fourth practical examples, ΔT100, ΔT25, and ΔT100−25 are all reduced, as compared with the first comparative example.

Based on a comparison between the first practical example and the second practical example, it is apparent that, in the second practical example, ΔT100, ΔT25, and ΔT100−25 are further reduced, as compared with the first practical example.

Furthermore, based on a comparison between the third and fourth practical examples and the first and second practical examples, it is apparent that, in the third and fourth practical examples, ΔT100, ΔT25, and ΔT100−25 are all reduced, as compared with the first and second practical examples.

TABLE

| | ΔT100 | ΔT25 | ΔT100 − 25 |
|---|---|---|---|
| | (° C.) | (° C.) | (° C.) |
| FIRST PRACTICAL EXAMPLE | 3.2 | 0.7 | 2.5 |
| SECOND PRACTICAL EXAMPLE | 2.4 | 0.7 | 1.7 |
| THIRD PRACTICAL EXAMPLE | 1.2 | 0.3 | 0.9 |
| FOURTH PRACTICAL EXAMPLE | 1.2 | 0.3 | 0.9 |
| FIRST COMPARATIVE EXAMPLE | 6.3 | 2.1 | 4.2 |

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) A light emitting component comprising:
a substrate;
an array-like light source unit that is provided at the substrate and in which a plurality of light emitting elements are arranged in a first scanning direction;
a controller that is provided at the substrate and that controls an electric current to turn on and off each light emitting element of the light source unit;
a resistor that is provided at the substrate and alongside an end of the light source unit in the first scanning direction, the resistor limiting the electric current supplied to each light emitting element; and
a heat generator that is provided at the substrate and at a position located parallel to the first scanning direction of the light source unit and located away from the resistor, the heat generator generating a heat quantity that is smaller than a heat value dependent on electric power input to the resistor and that is proportional to the heat value.
(((2))) The light emitting component according to (((1))),
wherein the heat generator includes a single heat generator.
(((3))) The light emitting component according to (((2))),
wherein the single heat generator is disposed in correspondence with a position including a center in the first scanning direction of the light source unit.
(((4))) The light emitting component according to (((1))),
wherein the heat generator includes a plurality of heat generators.
(((5))) The light emitting component according to (((4))),
wherein the plurality of heat generators are symmetrically disposed with respect to a center in the first scanning direction of the light source unit.
(((6))) The light emitting component according to (((4))) or (((5))),
wherein at least one of the plurality of heat generators is disposed in correspondence with a region located toward a center in the first scanning direction of the light source unit.
(((7))) The light emitting component according to any one of (((1))) to (((6))),
wherein the heat generator also serves as a part of the resistor and is disposed by being changed from a position located alongside the end of the light source unit in the first scanning direction to the position located parallel to the first scanning direction of the light source unit.
(((8))) The light emitting component according to (((7))),
wherein the resistor is divided into a plurality of sets in correspondence with division of an array of the light emitting elements of the light source unit into a plurality of sets, and wherein the heat generator is constituted by utilizing the resistor of any one of the sets.
(((9))) The light emitting component according to any one of (((1))) to (((8))), wherein, in view of a temperature distribution in the first scanning direction of the light source unit caused by heat generated by the resistor, the heat generator generates a heat quantity that reduces a variation difference in the temperature distribution.
(((10))) The light emitting component according to (((9))),
wherein the heat generator includes a plurality of heat generators, and wherein a heat quantity allocated to the heat generator located at a position toward a center in the first scanning direction of the light source unit is greater than a heat quantity allocated to a remaining one or more of the heat generators.
(((11))) The light emitting component according to any one of (((1))) to (((10))),
wherein the heat generator generates heat when the electric power input to the resistor is higher than or equal to a predetermined threshold value and does not generate heat when the electric power input to the resistor is lower than the threshold value.
(((12))) An optical writing device comprising:
the light emitting component according to any one of (((1))) to (((11))); and an imaging unit that causes light radiated from each light emitting element of the light emitting component to form an image at a predetermined position,
wherein the optical writing device writes the image according to the light.
(((13))) An image forming system comprising:
the optical writing device according to (((12))); and an image retainer that is provided facing the optical writing device and that retains the image according to the light written by the optical writing device.

What is claimed is:

1. A light emitting component comprising:
a substrate;
an array-like light source unit that is provided at the substrate and in which a plurality of light emitting elements are arranged in a first scanning direction;
a controller that is provided at the substrate and that controls an electric current to turn on and off each light emitting element of the light source unit;
a resistor that is provided at the substrate and alongside an end of the light source unit in the first scanning direction, the resistor limiting the electric current supplied to each light emitting element; and
a heat generator that is provided at the substrate and at a position located parallel to the first scanning direction of the light source unit and located away from the resistor, the heat generator generating a heat quantity that is smaller than a heat value dependent on electric power input to the resistor and that is proportional to the heat value.

2. The light emitting component according to claim 1,
wherein the heat generator includes a single heat generator.

3. The light emitting component according to claim 2,
wherein the single heat generator is disposed in correspondence with a position including a center in the first scanning direction of the light source unit.

4. The light emitting component according to claim 1,
wherein the heat generator includes a plurality of heat generators.

5. The light emitting component according to claim 4,
wherein the plurality of heat generators are symmetrically disposed with respect to a center in the first scanning direction of the light source unit.

6. The light emitting component according to claim 4,
wherein at least one of the plurality of heat generators is disposed in correspondence with a region located toward a center in the first scanning direction of the light source unit.

7. The light emitting component according to claim 1,
wherein the heat generator also serves as a part of the resistor and is disposed by being changed from a position located alongside the end of the light source unit in the first scanning direction to the position located parallel to the first scanning direction of the light source unit.

8. The light emitting component according to claim 7,
wherein the resistor is divided into a plurality of sets in correspondence with division of an array of the light emitting elements of the light source unit into a plurality of sets, and
wherein the heat generator is constituted by utilizing the resistor of any of the sets.

9. The light emitting component according to claim 1,
wherein, in view of a temperature distribution in the first scanning direction of the light source unit caused by heat generated by the resistor, the heat generator generates a heat quantity that reduces a variation difference in the temperature distribution.

10. The light emitting component according to claim 9,
wherein the heat generator includes a plurality of heat generators, and wherein a heat quantity allocated to the heat generator located at a position toward a center in the first scanning direction of the light source unit is greater than a heat quantity allocated to a remaining one or more of the heat generators.

11. The light emitting component according to claim 1,
wherein the heat generator generates heat when the electric power input to the resistor is higher than or equal to a predetermined threshold value and does not generate heat when the electric power input to the resistor is lower than the threshold value.

12. An optical writing device comprising:
the light emitting component according to claim 1; and
an imaging unit that causes light radiated from each light emitting element of the light emitting component to form an image at a predetermined position,
wherein the optical writing device writes the image according to the light.

13. An optical writing device comprising:
the light emitting component according to claim 2; and
an imaging unit that causes light radiated from each light emitting element of the light emitting component to form an image at a predetermined position,
wherein the optical writing device writes the image according to the light.

14. An optical writing device comprising:
the light emitting component according to claim 3; and
an imaging unit that causes light radiated from each light emitting element of the light emitting component to form an image at a predetermined position,
wherein the optical writing device writes the image according to the light.

15. An optical writing device comprising:
the light emitting component according to claim 4; and
an imaging unit that causes light radiated from each light emitting element of the light emitting component to form an image at a predetermined position,
wherein the optical writing device writes the image according to the light.

16. An optical writing device comprising:
the light emitting component according to claim 5; and
an imaging unit that causes light radiated from each light emitting element of the light emitting component to form an image at a predetermined position,
wherein the optical writing device writes the image according to the light.

17. An optical writing device comprising:
the light emitting component according to claim 6; and
an imaging unit that causes light radiated from each light emitting element of the light emitting component to form an image at a predetermined position,
wherein the optical writing device writes the image according to the light.

18. An optical writing device comprising:
the light emitting component according to claim 7; and
an imaging unit that causes light radiated from each light emitting element of the light emitting component to form an image at a predetermined position,
wherein the optical writing device writes the image according to the light.

19. An optical writing device comprising:
the light emitting component according to claim 8; and
an imaging unit that causes light radiated from each light emitting element of the light emitting component to form an image at a predetermined position,
wherein the optical writing device writes the image according to the light.

20. An image forming system comprising:
the optical writing device according to claim 12; and
an image retainer that is provided facing the optical writing device and that retains the image according to the light written by the optical writing device.
